(19) United States
(12) Patent Application Publication
(10) Pub. No.: US 2006/0253663 A1
(43) Pub. Date: Nov. 9, 2006

(54) Memory device and method having a data bypass path to allow rapid testing and calibration

(75) Inventors: James B. Johnson, Boise, ID (US); Troy A. Manning, Meridian, ID (US)

Correspondence Address: Edward W. Bulchis, Esq.;DORSEY & WHITNEY LLP, Suite 3400, 1420 Fifth Avenue, Seattle, WA, 98101, US

(73) Assignee: Micron Technology, Inc.

(21) Appl. No.: 11/124,002

(22) Filed: May 6, 2005

(51) Int. Cl. G06F 13/00

(52) U.S. Cl. 711/154

(57) ABSTRACT

A synchronous dynamic random access memory (“SDRAM”) device includes a pipelined write data path coupling data from a data bus to a DRAM array, and a pipelined read data path coupling read data from the array to the data bus. The SDRAM device also includes a bypass path allowing the write data in the write data path to be coupled directly to the read data path without first being stored in the DRAM array. The write data are preferably coupled through the write data path by issuing a write command to the DRAM device, and the read data are preferably coupled through the read data path by issuing a read command to the DRAM device. The memory array is inhibited from responding to these commands so that the write data are not stored in the array, and read data from the array are not coupled to the read data path.

The present invention relates generally to the testing and/or calibration of memory devices, and, more specifically, to a method and apparatus for allowing the write and read data path of memory devices to be tested and/or calibrated in a manner that does not require the involvement of memory cells in the device.

### BACKGROUND OF THE INVENTION

During the manufacture of memory devices, such as dynamic random access memory (“DRAM”) devices, it is necessary to test the memory device to assure that it is operating properly. FIG. 1 shows a typical data path 10 portion of a memory device, which includes a write data path 12 and a read data path 14 coupled between a data bus terminal 16 and array interface logic 20. The array interface logic 20 is, in turn, coupled to an array 22 of memory cells. In practice, a large number of data bus terminals 16 are included in the memory device 10, and each of these is coupled to a respective write data path 12 and read data path 14. However, in the interests of clarity, only the write data path 12 and read data path 14 coupled to one data bus terminal 16 is shown in FIG. 1.

The write data path 12 includes a receiver 30, which couples write data applied to the terminal 16 to a write data capture circuit 34. Each bit of write data output from the receiver 30 is captured or stored in the write data capture circuit 34 responsive to a write strobe (“WS”) signal. The WS signal is generally coupled to the memory device 10 from an external source, such as a memory controller (not shown in FIG. 1). Each bit of captured write data is divided into rising edge data at falling edge data and is applied to a serial-to-parallel converter 38, and is stored therein responsive to the WS signal. After a number of bits of write data have been applied to the data bus terminal 16 and stored in the serial-to-parallel converter 38, the stored write data bits are output in parallel form to the array interface logic 20 through an internal write data bus 40. In one embodiment, the serial-to-parallel converter 38 may be a series of shift registers coupled in series with each other, the first of which is coupled to the write data capture circuit 34. Respective outputs from all of the shift registers would then be coupled to the write data bus 40. If, for example, the serial-to-parallel converter 38 stores 4 write data bits, the write data bus 40 will have a width of 4 bits. The parallel-to-serial converter 38 also applies a write data valid signal to the array interface logic 20 when it is outputting valid write data to the array interface logic 20. The write data valid signal enables the array interface logic 20 to store the write data.

The array interface logic 20 receives a number of control signals from a command decoder (not shown in FIG. 1), including an array cycle signal, a write enable (“WE”) signal, and address signals, which are generally in the form of row address signals and column address signals. The array interface logic 20 stores the write data coupled through the write bus 40 in the memory cell array 22 at locations that are designated by the address.

The read data path 14 includes a data pipeline circuit 50 coupled to the array interface logic through an internal read data bus 52. The data pipeline circuit 50 receives parallel read data from the array interface logic 20, which, in turn, receives the read data from a location in the memory cell array 22 determined by the address applied to the logic 20. The WE signal determines whether write data is coupled to the array 22 or read data is coupled from the array 22. The array interface logic 20 also applies a read valid signal to the data pipeline circuit 50 when valid read data is being applied to the internal read data bus 52. The read data valid signal and a separate enable (“En”) signal enables the data pipeline circuit 50 to store the read data responsive to a read clock signal (“Rd Clk”).

The read data bits stored in the data pipeline circuit 50 are sequentially stored in a read data latch 56 responsive to the Rd Clk signal when the latch 56 is enabled by the En signal. The latch 56 then applies each latched read data bit to the data bus terminal 16 through a transmitter 58. In one embodiment, the data pipeline circuit 50 may be a series of shift registers each having an input coupled to a respective line of the read data bus 52. The output of the final shift register in the series would then be coupled to the read data latch 56.

A typical memory write operation followed by a memory read operation in the memory device 10 shown in FIG. 1 is shown in the timing diagram of FIG. 2. The data present on the data bus is shown as the upper signal in FIG. 2. Four bits of write data are sequentially applied to the data bus terminal 16 and latched in the write capture circuit 34 responsive to four transitions of the WS signal, which occur at approximately the middle of the time that each write data bit is valid. As each bit of write data is latched in the write data capture circuit 34, it is transferred to the serial-to-parallel converter 38. When all four bits of write data have been transferred to the serial-to-parallel converter 38, the converter 38 outputs a write valid signal at the same time that the four bits of write data are placed on the internal write bus 40, as also shown in FIG. 2. The command decoder (not shown in FIG. 2) outputs an Array Cycle signal to the array interface logic 20 at the same time that the serial-to-parallel converter 38 outputs the write valid signal. The Array Cycle signal initiates all read and write accesses to the memory cell array 22. The Array Cycle signal becomes valid following data de-serialization of the write data when the write data bits transferred to the serial-to-parallel converter 38 are output on the internal write data bus 40. The command decoder now also outputs an active write enable WE signal at the same time it outputs the Array Cycle signal. The WE signal allows the array interface logic 20 to determine that the memory access is a write memory access. The write data on the internal write data bus 40 are then stored in the memory cell array 22 at a location designated by the Address applied to the array interface logic 20.

After the write data have been stored in the array 22, the read memory access is initiated. This access is initiated by the command decoder applying an active Array Cycle signal to the array interface logic 20 while deasserting the WE signal. Four bits of data stored in the array 22 are then coupled to the array interface logic 20, which outputs the read data bits on the read data bus 52 at the same time that the logic 20 outputs a read valid signal. The read valid signal is generated by the array interface logic 20 to indicate the read data bits are being coupled from the memory cell array 22. The four bits of read data are stored in the read data pipeline circuit 50 responsive to the Rd Clk signal when the En signal transitions active high. The En signal, which is generated by the command decoder, also enables the read data pipeline circuit to sequentially output the four bits of read data responsive to the Rd Clk signal. As shown in FIG. 2, the Rd Clk signal is a free-running clock signal, which is normally generated by a delay-locked loop (not shown) in the memory device 10. The Rd Clk signal also enables the read data latch circuit 56 to latch and then output each bit of read data responsive to the Rd Clk signal. Each bit of read data is then sequentially applied to the data bus terminal 16 through the read data transmitter 58.

Electronic systems containing memory devices, such as computers, normally test the memory device 10 when power is initially applied to the system. In order to assure that each memory cell is operating properly, prior art test methods couple write data having a first binary value (e.g., a 1) to the data bus terminal 16 of the memory device 10. The write data are then coupled through the write data path 12 to the memory cell array 22. In a subsequent read operation, the stored write data are read from the array, and coupled to the data bus terminal 16 through the read data path 14. The read data are then compared to the write data by an external device. In the event of a match, the memory device 10 is considered to have passed the test. If there is no match, the memory device 10 is considered to have failed the test.

The memory device 10 may fail the test for a variety of reasons. The memory array 22 or circuits associated with the memory array 22, such as address decoders (not shown in FIG. 1), may be faulty so that the data are not written to and then read from the array 22. There may also be a fault in either the write data path 12 or the read data path 14. On the other hand, the problem may be simply a matter of timing tolerances in either the write data path 12 or the read data path 14 that could be cured by simply operating the device 10 at a slower speed. In such case, the memory device 10 could be salvaged by simply grading the device as a lower speed memory device. Unfortunately, using the test procedure described above, it is not possible to test only the write data path 12 or the read data path 14 since the memory array 22 plays an essential role in the test procedure.

Another procedure in which data are first written to and then read from the memory device 10 is in a procedure to calibrate the timing of signals coupled to or from memory devices. In modern high speed synchronous memory devices, such as SDRAM devices, it is desirable to adjust the timing of the write data strobe WS signals used to capture the write data in the write data capture circuit 34 and/or the timing of the Rd Clk signals used to latch read data in the read data latch 56. Both of these adjustments to the timing of the WS and Rd Clk signals may be made in either the memory device or the memory controller.

The optimum timing of the WS signal and/or the Rd Clk signal is determined in a calibration procedure in which attempts are made to capture write data in the write data capture circuit 34 or latch read data in the read data latch 56 using respective WS and Rd Clk signals having timing that varies within a predetermine range. The timing of the WS and Rd Clk signals that best captures the write data and/or read data is then used during normal operation.

A substantial amount of time can be required to perform this calibration procedure because it is necessary to write data to the memory array 22 and then read the data from the memory array 22 at each of a number of WS and Rd Clk signal times. As a result, the calibration procedures can undesirably delay the use of the memory device 10 in normal operation.

There is therefore a need for a memory device and method that allows more rapid testing and calibration of memory devices.

### SUMMARY OF THE INVENTION

A memory device includes a bypass path that allows write data coupled through a write data path to be coupled directly to a read data path with or without the write data being stored in a memory array. The data coupled to the read data path are then coupled through the read data path to external data bus terminals. As a result, the write data path and the read data path can be tested and/or calibrated without the involvement of the memory array. The bypass path can include a dedicated component such as a bypass driver coupled between the write data path or the read data path. Alternatively, the bypass path may be in another form such as a common connection between the read and write data paths and an input/output line coupled to the memory array that is typically used in memory devices.

### BRIEF DESCRIPTION OF THE DRAWINGS

FIG. 1 is a block diagram of a portion of a conventional memory device showing the write data path and read data path of the memory device.

FIG. 2 is a timing diagram showing the signals present in the portion of the memory device shown in FIG. 1 for a write memory access followed by a read memory access.

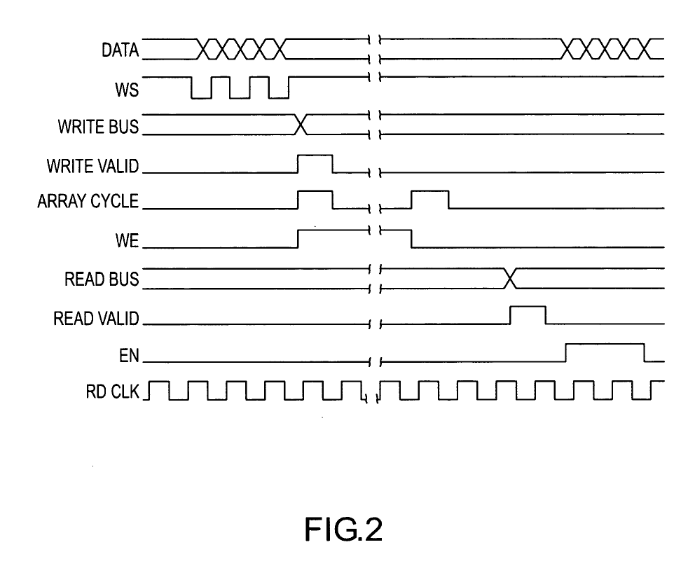

FIG. 3 is a block diagram showing a portion of a memory device according to one example of the present invention.

FIG. 4 is a more detailed block diagram showing array interface logic according to one example of the present invention that may be used in the portion of the memory device shown in FIG. 1.

FIG. 5 is a block diagram showing a portion of a memory device according to another example of the present invention.

FIG. 6 is a block diagram of a memory device using a bypass path as shown in FIGS. 3-5 or some other example of the present invention.

FIG. 7 is a block diagram of a processor-based system using the memory device of FIG. 6.

### DETAILED DESCRIPTION OF PREFERRED EMBODIMENTS

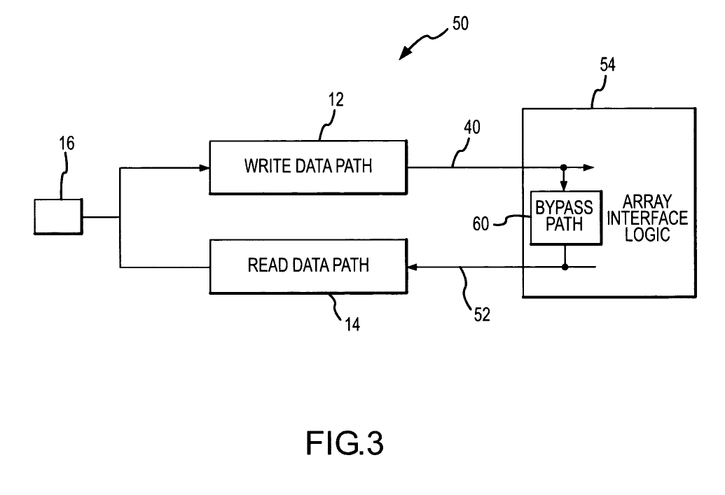

A portion of a memory device 50 according to one example of the present invention is shown in FIG. 3. The memory device 50 may be a dynamic random access memory (“DRAM”) device, a static random access memory (“SRAM”) device, or some other type of memory device. As previously explained, write data bits are applied to the data bus terminal 16 and coupled through the write data path 12 to array interface logic 54 through the internal write data bus 40. Read data bits are coupled from the array interface logic 54 to the data bus terminal 16 through the internal read data bus 52 and the read data path 14.

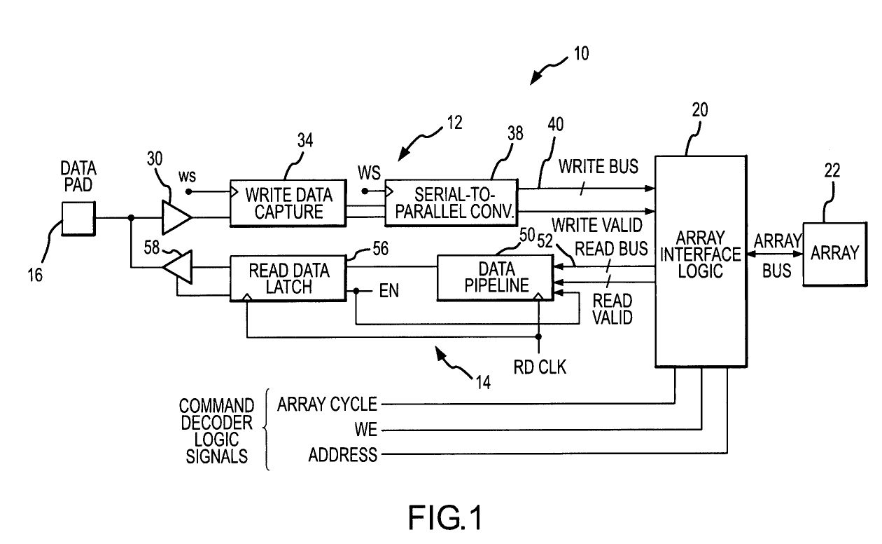

According to one example of the present invention, the array interface logic 54 includes a bypass path 60 that allows write data to be coupled from the write data bus 40 directly to the read data bus 52 without being applied to the memory cell array 22 (FIG. 1). As a result, the memory cell array 22 need not be involved in the testing of the write data path 12 or the read data path 14. A fault in the memory device 50 can therefore be isolated to the data paths 12, 14. Furthermore, during a calibration procedure in which the timing of a write data strobe WS signal and/or the timing of a read clock Rd Clk signal is adjusted for optimum performance as explained above, is not necessary to wait for the write data to be stored in the array 22 and then read from the array 22. As a result, the optimum timing of the WS signal and/or Rd Clk signal can be determined substantially more quickly. Although the bypass path 60 is shown as being part of the array interface logic 54, it will be understood that it can be a separate component or it can be included in a component other than the array interface logic 54.

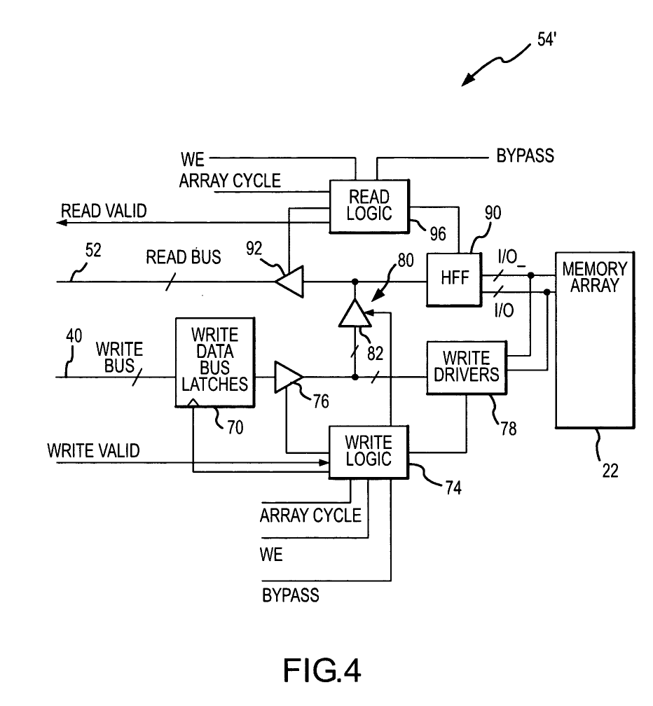

The manner in which a bypass path can be implemented in another example of array interface logic 54′ according to the present invention is shown in FIG. 4. The write data is coupled in parallel form through the write data bus 40 to a write data bus latch 70. The write data bus latches 70 store the write data responsive to a strobe signal coupled to the latches 70 from write logic 74 when the write logic 74 receives the Write Valid signal. The write logic 74 receives the Array Cycle signal, the write enable WE signal and a Bypass signal from the command decoder (not shown in FIG. 4). The Bypass signal may be a signal generated by a mode register in the command decoder, which is programmed by a user to enable the bypassing of the array 22 during testing and/or calibration. As is well known in the art, memory devices typically include a mode register to allow users to selectively enable or disable particular features or operating modes.

The write data stored in the write data bus latches 70 are coupled through a write data receiver 76 to a driver 78, both of which are controlled by signals from the write logic 74. The write driver 78 apply the write data to the memory array 22 through complementary input/output (“I/O”) lines. The write data are then stored in the memory array 22.

The write data receiver 76 also applies the write data to a bypass path 80 by a bypass driver 82, which is controlled by the write logic 74. As explained greater detail below, the bypass path 80 allows the write data to be coupled directly to the read data path without being stored in the memory array 22.

Read data from the memory array 22 are coupled through the complementary I/O lines to helper flip-flops (“HF-F) 90 which store the read data and apply the read data to a read data transmitter 92. Both the helper flip-flops 90 and the read data transmitter 92 are controlled by read logic 96, which receives the Array Cycle signal, the WE signal and in the Bypass signal from the command decoder (not shown in FIG. 4). The read data transmitter 92 then couples the read data through the internal read data bus 52, at which time the read logic 96 outputs the Read Valid signal, as previously explained.

In operation, the memory device operates in either a normal operating mode or a test/calibration mode. The test/calibration mode is enabled by the user programming the mode register to assert the Bypass signal. In response to a write command when the memory device is in the normal operating mode, write data coupled through the write data bus 40 are captured by the write data bus latches 70 and coupled through the write data bus drivers 76 and write driver 78 to the memory array 22. The write data are then stored in the memory array 22. In response to a read command, read data are output from the memory array 22 and coupled through the helper flip-flops 90 and read data transmitter 92 to the internal read data bus 52.

In the test/calibration mode, write data coupled through the write bus 40 are captured in the write data latches 70 and coupled through the write data receiver 76. However, the write logic 74 responds to the asserted Bypass signal by disabling the write driver 78 so that the write data are not coupled to the memory array 22. Instead, the write logic 74 enables the bypass driver 82 so that the write data are coupled directly to the internal read data bus 52 through the read data transmitter 92. During this procedure, and the timing of the write strobe WS signal applied to the write data capture circuit 34 (FIG. 1) and serial-to-parallel converter 38 can be varied to determine the optimum timing of the WS signal. Similarly, the timing of the read clock Rd Clk signal can be varied to determine the optimum timing of the Rd Clk signal. Significantly, it is not necessary for the write data to be stored in the memory array 22 and then subsequently read from the memory array 22 thus allowing the test and/or calibration procedure to be conducted in significantly less time.

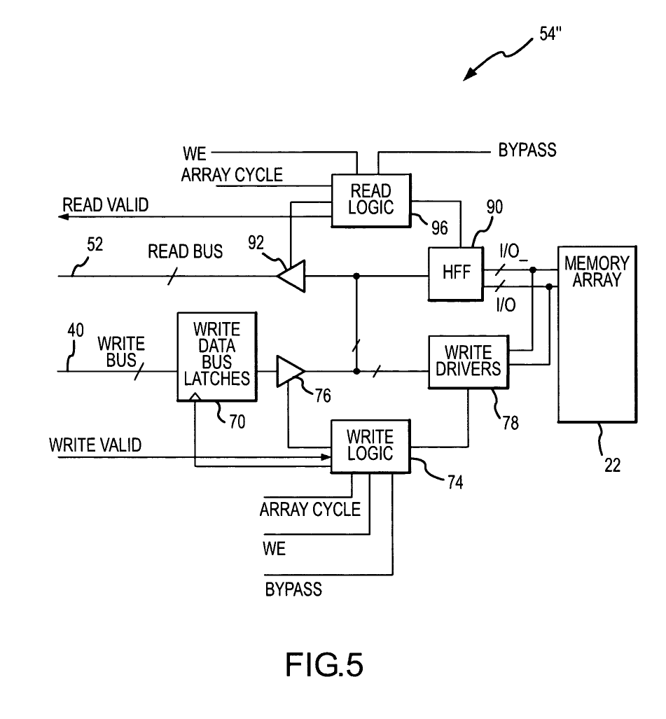

Another example of a bypass path used in the array interface logic 54″ is shown in FIG. 5. In this embodiment, the array interface logic 54″ includes all of the components that are used in the array interface logic 54′ of FIG. 4 except for the bypass driver 82. Furthermore, in the normal operating mode, the array interface logic 54″ operates in the same manner as the array interface logic 54′. However, rather than bypassing the memory array 22 by coupling write data directly from the write data path to the read data path using the bypass driver 82, the common connection between the write data path and the read data path at the I/O lines is used to bypass the memory array 22. This is accomplished by modifying a conventional memory array 22 so that, in the Bypass mode, the memory array 22 is inhibited from responding to normal write command and read commands. More particularly, the bypass signal, when asserted, suppresses write drivers in the memory array 22 so that the write data coupled to the I/O lines is not coupled to memory cells in the array 22. The asserted Bypass signal also disables column decoders in the memory devices so that data bits present on the digit lines of the array 22 responsive to a word line being activated are not coupled to the I/O lines. Significantly, components of the read data path and write data path are not inhibited by the asserted Bypass signal so that they couple the write data from the data bus terminal 16 (FIG. 3) to the I/O lines, and from the I/O lines back to the data bus terminal 16. Although the embodiment shown in FIG. 5 inhibits the operation of the array 22 by inhibiting write drivers and column decoders as explained above, it will be understood that other techniques may be used to prevent the memory array 22 from responding to write data bits present on the I/O lines and from placing read data bits on the I/O lines.

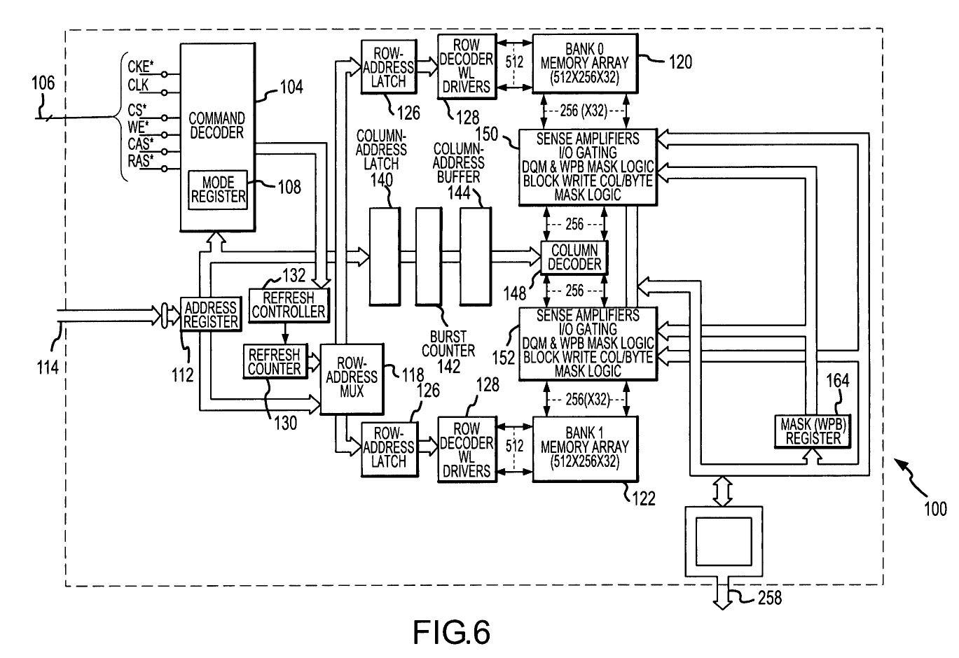

A memory device using the embodiment shown in FIG. 3 or some other example of the invention is shown in FIG. 6. The memory device is a conventional synchronous dynamic random access memory (“SDRAM”) 100. However, it will be understood that memory arrays may be bypassed according to various examples the present invention can also be used in other types of memory devices. The operation of the SDRAM 100 is controlled by a command decoder 104 responsive to high level command signals received on a control bus 106. These high level command signals, which are typically generated by a memory controller (not shown in FIG. 6), are a clock enable signal CKE*, a clock signal CLK, a chip select signal CS*, a write enable signal WE*, a row address strobe signal RAS*, and a column address strobe signal CAS*, in which the “*” designates the signal as active low. The command decoder 104 generates a sequence of command signals responsive to the high level command signals to carry out the function (e.g., a read or a write) designated by each of the high level command signals. These command signals, and the manner in which they accomplish their respective functions, are conventional. Therefore, in the interest of brevity, a further explanation of these control signals will be omitted.

The command decoder 104 includes a conventional mode register 108 of the type that is conventionally programmed by a user to select various operating modes or features. According to one example of the present invention, the mode register 108 is programmed to produce the Bypass signal when the test/calibration mode is to be enabled.

The SDRAM 100 includes an address register 112 that receives either a row address or a column address on an address bus 114. The address bus 114 is generally coupled to a memory controller (not shown in FIG. 6). Typically, a row address is initially received by the address register 112 and applied to a row address multiplexer 118. The row address multiplexer 118 couples the row address to a number of components associated with either of two memory arrays 120, 122 depending upon the state of a bank address bit forming part of the row address. Associated with each of the memory arrays 120, 122 is a respective row address latch 126, which stores the row address, and a row decoder 128, which decodes the row address and applies corresponding signals to one of the arrays 120 or 122.

The row address multiplexer 118 also couples row addresses to the row address latches 126 for the purpose of refreshing the memory cells in the arrays 120, 122. The row addresses are generated for refresh purposes by a refresh counter 130, which is controlled by a refresh controller 132. The refresh controller 132 is, in turn, controlled by the command decoder 104.

After the row address has been applied to the address register 112 and stored in one of the row address latches 126, a column address is applied to the address register 112. The address register 112 couples the column address to a column address latch 140. Depending on the operating mode of the SDRAM 100, the column address is either coupled through a burst counter 142 to a column address buffer 144, or to the burst counter 142 which applies a sequence of column addresses to the column address buffer 144 starting at the column address output by the address register 112. In either case, the column address buffer 144 applies a column address to a column decoder 148, which applies various column signals to corresponding sense amplifiers and associated column circuitry 150, 152 for one of the respective arrays 120, 122.

Data to be read from one of the arrays 120, 122 is coupled to the column circuitry 150, 152 for one of the arrays 120, 122, respectively. The read data is then coupled through the read data path 14 (FIG. 3) to the data bus terminals 16. Data to be written to one of the arrays 120, 122 are coupled from the data bus terminals 16 through the write data path 12 to the column circuitry 150, 152 where the write data may be transferred to one of the arrays 120, 122, respectively. In accordance with the disclosed examples of the invention or other embodiments of the invention, the write data may be coupled through the write data path 12 directly to the read data path 14 without being stored in one of the arrays 120, 122. A mask register 164 may be used to selectively alter the flow of data into and out of the column circuitry 150, 152, such as by selectively masking data to be read from the arrays 120, 122.

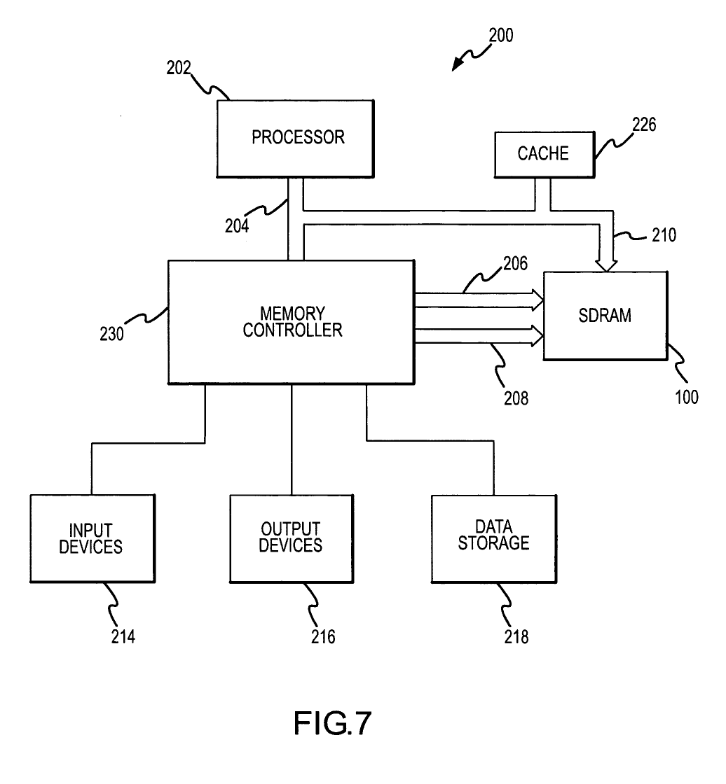

FIG. 7 shows an embodiment of a computer system 200 that may use the SDRAM 100 or some other memory device that contains one or more examples of the memory array bypass system and method according to the present invention. The computer system 200 includes a processor 202 for performing various computing functions, such as executing specific software to perform specific calculations or tasks. The processor 202 includes a processor bus 204 that normally includes an address bus 206, a control bus 208, and a data bus 210. In addition, the computer system 200 includes one or more input devices 214, such as a keyboard or a mouse, coupled to the processor 202 to allow an operator to interface with the computer system 200. Typically, the computer system 200 also includes one or more output devices 216 coupled to the processor 202, such output devices typically being a printer or a video terminal. One or more data storage devices 218 are also typically coupled to the processor 202 to store data or retrieve data from external storage media (not shown). Examples of typical storage devices 218 include hard and floppy disks, tape cassettes, and compact disk read-only memories (CD-ROMs). The processor 202 is also typically coupled to a cache memory 226, which is usually static random access memory (“SRAM”) and to the SDRAM 100 through a memory controller 230. The memory controller 230 includes an address bus coupled to the address bus 114 (FIG. 6) to couple row addresses and column addresses to the SDRAM 100, as previously explained. The memory controller 230 also includes a control bus that couples command signals to a control bus 106 of the SDRAM 100. The external data bus 258 of the SDRAM 100 is coupled to the data bus 210 of the processor 202, either directly or through the memory controller 230.

Although the present invention has been described with reference to the disclosed embodiments, persons skilled in the art will recognize that changes may be made in form and detail without departing from the spirit and scope of the invention. Accordingly, the invention is not limited except as by the appended claims.

What is claimed is:

1. A method of coupling data to and from a memory device having a write data path, a read data path and a memory array coupled to the read data path and the write data path, the method comprising:
applying data to the write data path;
allowing the data to be coupled through the write data path toward the memory array;
coupling the data from the write data path to the read data path without first allowing the data to be stored in the memory array; and
allowing the data to be coupled through the read data path away from the memory array.

2. The method of claim 1 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

3. The method of claim 2, further comprising inhibiting the data from being stored in the memory array.

4. The method of claim 1 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

5. The method of claim 1 wherein the act of coupling the data from the write data path to the read data path without first allowing the data to be stored in the memory array comprises:
selectively coupling the write data path to the read data path while the data are be coupled through the write data path toward the memory array; and
selectively isolating the write data path from the read data path to prevent the data from the write data path from being coupled to the read data path.

6. The method of claim 1 wherein the act of allowing the data to be coupled through the write data path toward the memory array comprises:
coupling a write memory command to the memory device; and
allowing the data to be coupled through the write data path responsive to the write memory command.

7. The method of claim 6 wherein the act of allowing the data to be coupled through the read data path away from the memory array comprises:
coupling a read memory command to the memory device; and
allowing the data to be coupled through the read data path responsive to the read memory command.

8. The method of claim 6, further comprising inhibiting the memory array from responding to the write memory command.

9. The method of claim 1 wherein the act of allowing the data to be coupled through the read data path away from the memory array comprises:
coupling a read memory command to the memory device; and
allowing the data to be coupled through the read data path responsive to the read memory command.

10. The method of claim 9, further comprising inhibiting the memory array from responding to the read memory command.

11. A method of testing a write data path and a read data path in a memory device having data bus terminals coupled to a memory array through the read data path and the write data path, the method comprising:
applying predetermined data to the data bus terminals;
allowing the data to be coupled from the data bus terminals through the write data path toward the memory array;
coupling the data from the write data path to the read data path without first allowing the data to be stored in the memory array;
allowing the data to be coupled through the read data path to the data bus terminals;
receiving the data at the data bus terminals; and
comparing the received data to the predetermined data to determine if the read data path and the write data path are properly functioning.

12. The method of claim 11 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

13. The method of claim 12, further comprising inhibiting the data from being stored in the memory array.

14. The method of claim 11 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

15. The method of claim 11 wherein the act of coupling the data from the write data path to the read data path without first allowing the data to be stored in the memory array comprises:
selectively coupling the write data path to the read data path while the data are be coupled through the write data path toward the memory array; and
selectively isolating the write data path from the read data path to prevent the data from the write data path from being coupled to the read data path.

16. The method of claim 11 wherein the act of allowing the data to be coupled through the write data path toward the memory array comprises:
coupling a write memory command to the memory device; and
allowing the data to be coupled through the write data path responsive to the write memory command.

17. The method of claim 16 wherein the act of allowing the data to be coupled through the read data path to the data bus terminals comprises:
coupling a read memory command to the memory device; and
allowing the data to be coupled through the read data path responsive to the read memory command.

18. The method of claim 16, further comprising inhibiting the memory array from responding to the write memory command.

19. The method of claim 11 wherein the act of allowing the data to be coupled through the read data path away to the data bus terminals comprises:
coupling a read memory command to the memory device; and
allowing the data to be coupled through the read data path responsive to the read memory command.

20. The method of claim 19, further comprising inhibiting the memory array from responding to the read memory command.

21. A method of calibrating a timing signal applied to a memory device to determine the timing that should be used to allow the timing signal to capture write data signals that are coupled through a write data path to a memory array, the memory device further including a read data path coupled to the memory array, the method comprising:
applying the timing signal to the memory device over a range to times relative to at least one other signal applied to the memory device;
applying predetermined data to the data bus terminals as each of the timing signals in the ranges is applied to the memory device;
using the timing signals applied to the memory device over the range of times to latch the respective data applied to the data bus terminals;
allowing the latched data to be coupled through the write data path toward the memory array;
coupling the data from the write data path to the read data path without first allowing the data to be stored in the memory array;
allowing the data to be coupled through the read data path to the data bus terminals;
examining the data coupled to the data bus terminals to determine if the data matches the predetermined data for each of the timing signals in the range of times; and
selecting one of the times in the ranges of timing signal times based on the examination of the data coupled to the data bus terminals.

22. The method of claim 21 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

23. The method of claim 22, further comprising inhibiting the data from being stored in the memory array.

24. The method of claim 21 wherein the act of coupling the data from the write data path to the read data path without first allowing the data to be stored in the memory array comprises:
coupling the data from the write data path to an input/output line that is coupled directly to the memory array; and
coupling the data from the input/output line to the read data path.

25. The method of claim 21 wherein the act of coupling the data from the write data path to the read data path without first allowing the data to be stored in the memory array comprises:
selectively coupling the write data path to the read data path while the data are be coupled through the write data path toward the memory array; and
selectively isolating the write data path from the read data path to prevent the data from the write data path from being coupled to the read data path.

26. The method of claim 21 wherein the act of allowing the data to be coupled through the write data path toward the memory array comprises:
coupling a write memory command to the memory device; and
allowing the data to be coupled through the write data path responsive to the write memory command.

27. The method of claim 26 wherein the act of allowing the data to be coupled through the read data path to the data bus terminals comprises:
coupling a read memory command to the memory device; and
allowing the data to be coupled through the read data path responsive to the read memory command.

28. The method of claim 26, further comprising inhibiting the memory array from responding to the write memory command.

29. The method of claim 21 wherein the act of allowing the data to be coupled through the read data path away to the data bus terminals comprises:
coupling a read memory command to the memory device; and
allowing the data to be coupled through the read data path responsive to the read memory command.

30. The method of claim 29, further comprising inhibiting the memory array from responding to the read memory command.

31. The method of claim 21 wherein the timing signal comprises a write data strobe signal.

32. A memory device, comprising:
a row address circuit operable to receive and decode row address signals applied to external address terminals of the memory device;
a column address circuit operable to receive and decode column address signals applied to the external address terminals;
a memory cell array operable to store data written to and read from the array at a location determined by the decoded row address signals and the decoded column address signals;
a command decoder operable to decode a plurality of command signals applied to respective external command terminals of the memory device, the command decoder being operable to generate control signals corresponding to the decoded command signals;
a read data path circuit operable to couple read data from the memory cell array to external data terminals of the memory device;
a write data path circuit operable to couple write data from the external data terminals of the memory device to the memory cell array; and
a bypass path coupling the write data from the write data path to the read data path without first allowing the write data to be stored in the memory cell array.

33. The memory device of claim 32 wherein the bypass path comprises an input/output line coupling to the memory cell array, the read data path and the write data path.

34. The memory device of claim 32 wherein the bypass path comprises a bypass driver having an input coupled to a signal node of the write data path and an output coupled to a signal node of the read data path.

35. The memory device of claim 34 wherein the bypass driver is selectively enabled.

36. The memory device of claim 32 further comprising inhibit circuitry operable to inhibit the write data from being stored in the memory cell array.

37. The memory device of claim 32 wherein the write data path comprises a write latch having a data input coupled to the external data terminals and a clock input coupled to receive a write data strobe signal, the write latch being operable to latch a bit of the write data applied to the external data terminals responsive to respective ones of the write data strobe signals.

38. The memory device of claim 37 wherein the write data path further comprises a serial-to-parallel converter having an input terminal coupled to the write latch, the serial-to-parallel converter being operable to sequentially store a plurality of the write data bits received from the write latch and to output a plurality of the stored write data bits to the memory cell array in parallel form.

39. The memory device of claim 32 wherein the read data path comprises a parallel-to-serial converter having an input bus coupled to the memory cell array to receive a plurality of bits of read data from the array in parallel form, the parallel-to-serial converter being operable to sequentially output the read data bits to the external data terminals in serial form.

40. The memory device of claim 39 wherein the read data path further comprises a read data latch sequentially receiving the read data bits from the parallel-to-serial converter, the read data latch storing each of the read data bits and coupling each of the stored read data bits to the external data terminals responsive to respective read data strobe signals.

41. The memory device of claim 32 wherein the write data are coupled through the write data path responsive to control signal output from the command decoder responsive to decoding a write command.

42. The memory device of claim 32 wherein the read data are coupled through the read data path responsive to control signal output from the command decoder responsive to decoding a read command.

43. The memory device of claim 32 wherein the memory cell array comprises an array of dynamic random access memory cells.

44. The memory device of claim 32 wherein the command decoder further comprises a mode register that is programmable by a user to output an enable signal that selectively enables the bypass path to couple the write data from the write data path to the read data path.

45. A processor-based system, comprising
a processor having a processor bus;
an input device coupled to the processor through the processor bus adapted to allow data to be entered into the computer system;
an output device coupled to the processor through the processor bus adapted to allow data to be output from the computer system; and
a memory device coupled to the processor bus adapted to allow data to be stored, the memory device comprising:
a row address circuit operable to receive and decode row address signals applied to external address terminals of the memory device;
a column address circuit operable to receive and decode column address signals applied to the external address terminals;
a memory cell array operable to store data written to and read from the array at a location determined by the decoded row address signals and the decoded column address signals;
a command decoder operable to decode a plurality of command signals applied to respective external command terminals of the memory device, the command decoder being operable to generate control signals corresponding to the decoded command signals;
a read data path circuit operable to couple read data from the memory cell array to external data terminals of the memory device;
a write data path circuit operable to couple write data from the external data terminals of the memory device to the memory cell array; and
a bypass path coupling the write data from the write data path to the read data path without first allowing the write data to be stored in the memory cell array.

46. The processor-based system of claim 45 wherein the bypass path comprises an input/output line coupling to the memory cell array, the read data path and the write data path.

47. The processor-based system of claim 45 wherein the bypass path comprises a bypass driver having an input coupled to a signal node of the write data path and an output coupled to a signal node of the read data path.

48. The processor-based system of claim 47 wherein the bypass driver is selectively enabled.

49. The processor-based system of claim 45 further comprising inhibit circuitry operable to inhibit the write data from being stored in the memory cell array.

50. The processor-based system of claim 45 wherein the write data path comprises a write latch having a data input coupled to the external data terminals and a clock input coupled to receive a write data strobe signal, the write latch being operable to latch a bit of the write data applied to the external data terminals responsive to respective ones of the write data strobe signals.

51. The processor-based system of claim 50 wherein the write data path further comprises a serial-to-parallel converter having an input terminal coupled to the write latch, the serial-to-parallel converter being operable to sequentially store a plurality of the write data bits received from the write latch and to output a plurality of the stored write data bits to the memory cell array in parallel form.

52. The processor-based system of claim 45 wherein the read data path comprises a parallel-to-serial converter having an input bus coupled to the memory cell array to receive a plurality of bits of read data from the array in parallel form, the parallel-to-serial converter being operable to sequentially output the read data bits to the external data terminals in serial form.

53. The processor-based system of claim 52 wherein the read data path further comprises a read data latch sequentially receiving the read data bits from the parallel-to-serial converter, the read data latch storing each of the read data bits and coupling each of the stored read data bits to the external data terminals responsive to respective read data strobe signals.

54. The processor-based system of claim 45 wherein the write data are coupled through the write data path responsive to control signal output from the command decoder responsive to decoding a write command.

55. The processor-based system of claim 45 wherein the read data are coupled through the read data path responsive to control signal output from the command decoder responsive to decoding a read command.

56. The processor-based system of claim 45 wherein the memory cell array comprises an array of dynamic random access memory cells.

57. The processor-based system of claim 45 wherein the command decoder further comprises a mode register that is programmable by a user to output an enable signal that selectively enables the bypass path to couple the write data from the write data path to the read data path.
